(19) United States
(12) Patent Application Publication
(10) Pub. No.: US 2022/0315504 A1
(43) Pub. Date: Oct. 6, 2022

(54) REGULATING SOLUTION, FERTILIZER AND SOIL CONDITIONER FOR INCREASING VITAMIN C CONTENT OF PLANTS AS WELL AS PREPARATION AND APPLICATION THEREOF

(71) Applicants: THE INSTITUTE OF APPLIED ECOLOGY, CHINESE ACADAMY OF SCIENCES, Shenyang, Liaoning (CN); SHENYANG YIKANG ENVIROMENTAL BIOTECHNOLOGY DEVELOPMENT CO. LTD, Shenyang, Liaoning (CN)

(72) Inventors: Hui XU, Shenyang, Liaoning (CN); Weichao YANG, Shenyang, Liaoning (CN); Hao SUN, Shenyang, Liaoning (CN); Mingfu GAO, Shenyang, Liaoning (CN); Haozhe XU, Shenyang, Liaoning (CN); Shuang KONG, Shenyang, Liaoning (CN)

(21) Appl. No.: 17/597,330

(22) PCT Filed: May 25, 2020
(86) PCT No.: PCT/CN2020/092068

§ 371 Date: Jan. 3, 2022

(30) Foreign Application Priority Data
Jul. 2, 2019 (CN) 201910588061.7
Dec. 3, 2019 (CN) 201911218824.5

(51) Int. Cl. C05G 3/80; C05G 5/23; C05F 11/00; C09K 17/14

(52) U.S. Cl. CPC C05G 3/80; C05G 5/23; C05F 11/00; C09K 17/14; C09K 2101/00

(57) ABSTRACT

The present invention relates to the technical field of fertilizer and soil conditioner production, and particularly to a regulating solution, fertilizer and soil conditioner for increasing Vitamin C (abbreviated as Vc, which is also known as ascorbic acid) content of plants as well as a preparation method therefor and application thereof. At the same time, the present invention also relates to a resource utilization technique of wasted liquid in the industrial production of vitamin C. The regulating solution is obtained by regulating the pH value of a wasted gulonic acid mother solution (a residue after evaporation of fermentation liquid from vitamin C industry) or/and 2-keto-L-gulonic acid solution by an alkaline solution, wherein a fertilizer regulating solution is obtained by regulating the pH value of the regulating solution to 3.0-9.0; and a soil conditioner regulating solution is obtained by regulating the pH value of the regulating solution to 2.0-10.0. The regulating solution obtained by the present invention and the fertilizer and soil conditioner prepared by using the regulating solution as a raw material can significantly increase Vc content of plants, and the effect can be found in all plants tested.

### TECHNICAL FIELD

The present invention relates to the technical field of fertilizer and soil conditioner production, and particularly to a regulating solution, fertilizer and soil conditioner for increasing Vc content of plants as well as a preparation method therefor and application thereof. At the same time, the present invention also relates to a resource utilization technique of wasted liquid in the industrial production of vitamin C.

### BACKGROUND

China is a big producer of vitamin C (abbreviated as Vc, which is also known as ascorbic acid), with an annual Vc yield of about 160,000-180,000 tons. A large amount of a wasted substance—wasted gulonic acid mother solution (a residue after evaporation of fermentation liquid from vitamin C industry)—is discharged in the production process of Vc. It is estimated that about 0.45 tons of the wasted gulonic acid mother solution will be discharged for every ton of Vc produced, and the annual discharge amount is about 70,000-80,000 tons in China. The wasted gulonic acid mother solution is a residual liquid of a fermented liquor after procedures such as ultrafiltration separation, ion exchange, triple effect evaporation, concentrating and gulonic acid crystallization in the production process of Vc. Main components of the wasted gulonic acid mother solution include 2-keto-L-gulonic acid (15%-35%), formic acid (1%-2%), oxalic acid (2%-3%), sorbose (1%-2%), protein and nucleic acid (3%-5%), etc., and the organic matter content thereof is as high as 40%-60%. The wasted gulonic acid mother solution is brownish black and viscous, with a specific gravity of 1.25-1.40, a COD value of 0.5-1×10⁶ mg/L and a pH of ≤0.5. The wasted gulonic acid mother solution is difficult to enter a sewage treatment system for anaerobic and aerobic treatments due to the extremely high COD; and it has been used for preparing oxalic acid, but brings more serious environmental pollution. At present, no effective way to utilize the wasted gulonic acid mother solution is available, which is a bottleneck restricting the sustainable and green development of Vc production enterprises. At the same time, the main components of the wasted gulonic acid mother solution include 2-keto-L-gulonic acid, the content of which is up to 15%-35%. 2-keto-L-gulonic acid is a precursor for synthesizing Vc in the industrial production of Vc, which is eventually converted into Vc after multiple steps of chemical catalytic reactions, but cannot spontaneously form Vc at room temperature and in the absence of catalytic reagents.

Plants are one of the main forms of life. Trees, shrubs, rattans, grasses, ferns, green algae, lichens, etc. are all plants. In taxonomy, plants can be divided into seed plants, bryophytes, ferns, gymnosperms, etc.

Vc is ubiquitous in plants, and plays an important role in plant growth and metabolism, especially in plant resistance to environmental stress. The increase of Vc content in plants can improve the quality and economic value of plants (such as crops, medicinal plants and flower plants), and Vc content is an important assessment index of the quality of plant products. However, so far, no effective, simple and inexpensive technique and method to greatly increase the Vc content of plants and plant products is available.

### SUMMARY

The purpose of the present invention is to provide a regulating solution, fertilizer and soil conditioner for increasing Vc content of plants, which uses a wasted gulonic acid mother solution or/and 2-keto-L-gulonic acid solution as a major raw material, as well as a preparation method therefor and application thereof.

To achieve the above purpose, the present invention adopts the following technical solution:

A regulating solution, fertilizer and soil conditioner for increasing Vc content of plants. The regulating solution is obtained by regulating the pH value of a wasted gulonic acid mother solution or/and 2-keto-L-gulonic acid solution by an alkaline solution, wherein a fertilizer regulating solution is obtained by regulating the pH value of the regulating solution to 3.0-9.0; and a soil conditioner regulating solution is obtained by regulating the pH value of the regulating solution to 2.0-10.0.

It can be seen that, according to the uses of the present invention, the regulating solution is divided into two categories, i.e., the fertilizer regulating solution and the regulating solution soil conditioner.

The alkaline solution is a solution with a concentration of 10-50 wt % prepared by an alkaline reagent and water, wherein the alkaline reagent is one or a mixture of more than one of sodium hydroxide, potassium hydroxide and liquid ammonia (but is not limited to the above alkaline reagents).

2-keto-L-gulonic acid used for preparing the fertilizer and soil conditioner is obtained by chemosynthesis or biosynthesis (by biosynthesis, the 2-keto-L-gulonic acid can be obtained by using sorbose as a substrate through microbial fermentation and transformation in a Vc production process).

Of the wasted gulonic acid mother solution or/and 2-keto-L-gulonic acid solution, the 2-keto-L-gulonic acid solution is obtained by chemosynthesis or biosynthesis (by biosynthesis, the 2-keto-L-gulonic acid can be obtained by using L-sorbose as a substrate through microbial fermentation and transformation in the Vc production process); and the wasted gulonic acid mother solution is a residual liquid of a Vc biological fermentation broth after procedures such as ultrafiltration separation, ion exchange, triple effect evaporation, concentration and 2-keto-L-gulonic acid crystallization (but is not limited to the above residual liquid).

The solution containing 2-keto-L-gulonic acid can be a residual liquid of a Vc fermentation broth in the process of producing gulonic acid crystals (after procedures such as ultrafiltration separation, ion exchange, concentration and gulonic acid crystallization), i.e., the wasted gulonic acid mother solution, and can also be the 2-keto-L-gulonic acid solution directly prepared by 2-keto-L-gulonic acid.

The wasted gulonic acid mother solution comes from the Vc production process, and is a residual liquid of a Vc biological fermentation broth after various procedures such as ultrafiltration separation, ion exchange, triple effect evaporation, concentration and gulonic acid crystallization. The main components of the gulonic acid mother solution include 2-keto-L-gulonic acid (15%-35%), protein and nucleic acid (3%-5%), etc. The gulonic acid mother solution has an organic matter content of 40%-60%, and contains small molecular organic acids, protein, nucleic acid, etc. The gulonic acid mother solution is brownish black and viscous, with a specific gravity of 1.20-1.40, a COD value of 1×10⁶ mg/L and a pH of ≤0.5.

Preferably, the pH value of the fertilizer regulating solution is regulated to 5.5-7.5; and the pH value of the soil conditioner regulating solution is regulated to 3.5-8.5.

A preparation method for the regulating solution, fertilizer and soil conditioner for increasing Vc content of plants. The regulating solution is obtained by regulating the pH value of a wasted gulonic acid mother solution or/and 2-keto-L-gulonic acid solution by an alkaline solution, wherein a fertilizer regulating solution is obtained by regulating the pH value of the regulating solution to 3.0-9.0; and a soil conditioner regulating solution is obtained by regulating the pH value of the regulating solution to 2.0-10.0.

Preferably, an acid-base reaction occurs between the gulonic acid mother solution or/and 2-keto-L-gulonic acid and the alkaline reagent in order to regulate the pH value of the reaction system; then the reaction system is placed in a reactor with an agitator and a jacketed water bath, and the reaction time is 10-120 minutes at 0° C.-60° C. to obtain the regulating solution;

An application of the regulating solution, fertilizer and soil conditioner for increasing Vc content of plants, and the application of the fertilizer regulating solution in increasing Vc content of plants and yield of crops.

The application of the soil conditioner regulating solution in preparing the soil conditioner; further, the application of the soil conditioner in regulating soil environment and increasing Vc content and yield of plants.

The pH value of the fertilizer prepared by the fertilizer regulating solution is regulated to 5.5-7.5; and the pH value of the soil conditioner prepared by the soil conditioner regulating solution is regulated to 2.0-10.0.

The fertilizer regulating solution can be applied alone, or applied after being mixed with one or more of a chemical fertilizer, an organic fertilizer, a biological fertilizer, a fertilizer raw material and a fertilizer auxiliary material.

The fertilizer regulating solution can be applied alone, or applied as a base fertilizer, a top dressing, a water-soluble fertilizer or a foliar fertilizer when mixed with one or more of a chemical fertilizer, an organic fertilizer, a biological fertilizer, a chemical fertilizer raw material and a fertilizer auxiliary material.

The fertilizer regulating solution is applied after being mixed with the base fertilizer at a mass ratio of 1:0.1-50; the regulating solution is applied after being mixed with the top dressing at a mass ratio of 1:0.1-50; or the regulating solution is sprayed after being mixed with the foliar fertilizer at a mass ratio of 1:0.1-50 or sprayed alone.

The fertilizer regulating solution is mixed with the chemical fertilizer and the (biological) organic fertilizer in proportion to be used as a compound fertilizer, and the mixing ratio is 1:0-50:0-50 (mass ratio).

The fertilizer regulating solution is mixed with the chemical fertilizer raw material and the fertilizer auxiliary material in proportion to be used as a compound fertilizer, and the mixing ratio is 1:0-50:0-50 (mass ratio).

Plants are one of the main forms of life. Common trees, shrubs, rattans, grasses, ferns, green algae, lichens, etc. are all plants. In taxonomy, plants can be divided into seed plants, bryophytes, ferns, gymnosperms, etc.

The plants (including crops) refer to cultivated plants in agriculture/forestry, etc. and wild plants in nature, including food crops (such as rice, corn, bean, tuberous crops, highland barley, broad bean and wheat), oil crops (such as oilseed, turnip, leaf mustard, peanut, til, hemp and sunflower), vegetable crops (such as radish, Chinese cabbage, celery, Chinese chive, garlic, green onion, carrot, snake melon, cabbage, Jerusalem artichoke, sword bean, coriander, lettuce, daylily, hot pepper, cucumber, tomato and caraway), fruits (such as pear, green plum, apple, peach, apricot, walnut, plum, cherry, strawberry, crab apple and red date), feed crops (such as corn, green manure crops and Chinese milk vetch), medicinal crops (such as ginseng, Chinese angelica, honeysuckle, field mint, mugwort and ginkgo), ornamental plants (such as Chinese rose and rose), etc.

The commercial products of the chemical fertilizer, organic fertilizer and biological fertilizer, as well as those commercially available organic fertilizers and inorganic fertilizers. The organic fertilizers include farmyard manure, commercial organic fertilizers, biological organic fertilizers, organic-inorganic compound fertilizers, various amino acids, protein, humic acid fertilizers, etc. The inorganic fertilizers include nitrogenous fertilizers (such as urea, ammonium carbonate, ammonium chloride, ammonium sulphate and ammonium nitrate), phosphate fertilizers (such as calcium superphosphate, calcium magnesium phosphate and coarse whiting), potassium fertilizers (such as potassium chloride and potassium sulphate), compound fertilizers (such as ammonium phosphate, diammonium phosphate, potassium dihydrogen phosphate, potassium nitrate, various ternary or binary NPK compound fertilizers, and water-soluble fertilizers), secondary element fertilizers (such as magnesium potassium sulphate and magnesium potassium chloride), trace element fertilizers, etc.

Raw materials of the inorganic fertilizers include raw materials of macro-, secondary and trace element fertilizers. The raw materials of macro-, secondary and trace element fertilizers are mainly urea, ammonium chloride, ammonium nitrate, ammonium carbonate, calcium magnesium phosphate, calcium superphosphate, ammonium phosphate, diammonium phosphate, phosphoric acid, potassium chloride, potassium nitrate, phosphogypsum, ammonium sulphate, superphosphate, coarse whiting, magnesium sulphate, boric acid, borax, sodium decaborate, manganous sulphate monohydrate, manganous oxide, manganese chloride tetrahydrate, manganous carbonate, manganese dioxide, ferrous sulphate, zinc sulphate, zinc chloride, zinc carbonate, zinc phosphate, ammonium molybdate tetrahydrate, ammonium molybdate dihydrate, molybdenum trioxide, copper sulphate pentahydrate, copper carbonate, copper chloride, copper oxide and cuprous oxide.

The auxiliary material is one or a synthesis of more than one of an amino acid, a fertilizer synergist, a microbial inoculum, a humic acid and an organic raw material (such as turfy soil, livestock and poultry manure, manioc waste, edible fungi residue, manioc waste and sugar mill filter mud).

The soil conditioner is obtained by mixing the soil conditioner regulating solution with plant fibers at a mass ratio of 1:0-0.8 and drying the materials at a low temperature of 30° C.-60° C. after mixing well.

The plant fibers are one or more of crop straw, rice hull, bran, sawdust and bagasse, which are crushed to 20-100 meshes for use.

The soil conditioner can be applied alone, or applied as a compound conditioner after being mixed with one or more of another soil conditioner, a chemical fertilizer, an organic fertilizer, a biological fertilizer and a soil conditioner raw material.

The soil conditioner is a liquid or solid preparation.

The soil conditioner can be applied alone, or applied as a compound conditioner after being mixed with one or more of the products or raw materials of another soil conditioner, a chemical fertilizer and a (biological) organic fertilizer.

The plants/crops refer to various agricultural cultivated plants/nonagricultural plants, including food crops (such as rice, corn, bean, tuberous crops, highland barley, broad bean and wheat, etc.), oil crops (such as oilseed, turnip, leaf mustard, peanut, til, hemp and sunflower, etc.), vegetable crops (such as radish, Chinese cabbage, celery, Chinese chive, garlic, green onion, carrot, snake melon, cabbage, Jerusalem artichoke, sword bean, coriander, lettuce, daylily, hot pepper, cucumber, tomato and caraway, etc.), fruits (such as pear, green plum, apple, peach, apricot, walnut, plum, cherry, strawberry, crab apple and red date, etc.), feed crops (such as corn, green manure crops and Chinese milk vetch, etc.), medicinal crops (such as ginseng, Chinese angelica, honeysuckle, field mint, mugwort and ginkgo, etc.), ornamental plants (such as Chinese rose and rose, etc.), etc.

The soil conditioner can be applied to various obstacle soils, including sandy soil, saline-alkali soil, acid soil, structural obstacle soil, etc.

The commercial products of the chemical fertilizer, organic fertilizer and biological fertilizer include commercially available organic fertilizers and inorganic fertilizers. The organic fertilizers include farmyard manure, commercial organic fertilizers, biological organic fertilizers, organic-inorganic compound fertilizers, various amino acids, protein, humic fertilizers, etc. The inorganic fertilizers include nitrogenous fertilizers (such as urea, ammonium bicarbonate, ammonium chloride, ammonium sulphate and ammonium nitrate), phosphate fertilizers (such as calcium superphosphate, calcium magnesium phosphate and coarse whiting), potassium fertilizers (such as potassium chloride and potassium sulphate), compound fertilizers (such as monoammonium phosphate, diammonium phosphate, potassium dihydrogen phosphate, potassium nitrate, various ternary or binary NPK compound fertilizers, and water-soluble fertilizers), secondary element fertilizers (such as magnesium potassium sulphate and magnesium potassium chloride), trace element fertilizers, etc.

The commercial products of the soil conditioner include commercially available mineral source soil conditioners, organic source soil conditioners, chemical source soil conditioners, agroforestry water-keeping absorbent polymers and compound soil conditioners.

The raw materials of the inorganic fertilizers include raw materials of macro-, secondary and trace element fertilizers. The raw materials of macro-, secondary and trace element fertilizers are mainly urea, ammonium chloride, ammonium nitrate, ammonium bicarbonate, calcium magnesium phosphate, calcium superphosphate, monoammonium phosphate, diammonium phosphate, phosphoric acid, potassium chloride, potassium nitrate, phosphogypsum, ammonium sulphate, superphosphate, coarse whiting, magnesium sulphate, boric acid, borax, sodium decaborate, manganous sulphate monohydrate, manganous oxide, manganese chloride tetrahydrate, manganous carbonate, manganese dioxide, ferrous sulphate, zinc sulphate, zinc chloride, zinc carbonate, zinc phosphate, ammonium molybdate tetrahydrate, ammonium molybdate dihydrate, molybdenum trioxide, copper sulphate pentahydrate, copper carbonate, copper chloride, copper oxide and cuprous oxide.

The raw materials of the organic fertilizers include one or a synthesis of more than one of an amino acid, a fertilizer synergist, a biological microbial inoculum, a humic acid and an organic raw material (such as turfy soil, livestock and poultry manure, manioc waste, edible fungi residue, manioc waste and sugar mill filter mud, etc.).

The soil conditioner raw material includes: mineral source soil conditioner raw materials, such as limestone, dolomite, bentonite, peat, peat vivianite, vermiculite, diatomite, saponite, sepiolite and other minerals rich in the elements of calcium, magnesium, silicon, phosphorus, potassium, etc.; organic source soil conditioner raw materials, such as crop straw, a microbial inoculum, microbial fermentation product, fermentation industry wasted residue and wasted liquid, and kitchen waste, etc.; chemical source soil conditioner raw materials, including chemicals such as citric acid, polymaleic acid, and ammonium lauryl ethoxy sulphate; and water-keeping agroforestry absorbent polymer raw materials, including synthetic polymerization type, cellulose graft polymerization type and other types of water absorbent resin polymers, etc.

The present invention has the following advantages:

1. The regulating solution obtained by the present invention and the fertilizer and soil conditioner prepared by using the regulating solution as a raw material can significantly increase Vitamin C (abbreviated as Vc) content of plants, and the effect can be found in all plants tested. The regulating solution is rich in 2-keto-L-gulonic acid, a precursor for synthesizing Vitamin C in plants. It is assumed that 2-keto-L-gulonic acid is absorbed by plants, and is used directly (or after being modified by enzymes in plants) as a precursor to participate in and promote the synthesis of Vc in plants; at the same time, 2-keto-L-gulonic acid is also an intermediate product of Vc metabolic process in plants, which decreases the decomposition of Vc through feedback inhibition. Therefore, by providing 2-keto-L-gulonic acid to plants, this technique can not only increase Vc synthesis but also decrease Vc decomposition, so as to greatly increase the Vc content of plants. Thus, this technique can provide plant products rich in Vc for humans.

2. The gulonic acid mother solution used in the present invention is rich in a variety of short-chain organic acids, and has an organic matter content of up to 40%-60%, which can directly provide rich organic matter nutrients for the growth of plants (including crops, etc.), so as to improve biomass of plants (or yield of crops).

3. The gulonic acid mother solution used in the present invention is rich in a variety of short-chain organic acids, and has an organic matter content of up to 40%-60%, which improves soil acidity and alkalinity, increases the content of soil organic matters, provides abundant utilizable carbon source nutrients for the growth of soil microorganisms, increases the number and vitality of soil microorganisms, decreases the incidence of soil-borne diseases, provides rich nutrients that can be absorbed effectively for the growth of plants (crops), and promotes the growth of plants (crops), so as to improve soil quality, increase the yield and quality of agricultural products, and achieve the double effects of conditioning soil and improving the quality of agricultural products.

4. The present invention has flexible and diverse compound combination and use modes:

(1) The present invention uses the wasted gulonic acid mother solution as a major raw material, which can be applied, after treatment, as a nutrient regulating solution in the process of crop growth;

and can also be mixed with a finished product of a chemical fertilizer or an organic fertilizer to prepare a compound fertilizer; or mixed with an inorganic fertilizer raw material, a fertilizer auxiliary material, etc. in appropriate proportion to prepare a compound fertilizer, and form a fertilizer with multiple raw materials and multiple formulas and based on a wasted gulonic acid mother solution regulating solution, so as to meet the nutrient needs of different crops in different regions.

(2) The fertilizer regulating solution/fertilizer obtained by the present invention can be applied alone, and can also be applied as a compound fertilizer after being mixed with another chemical fertilizer and a biological fertilizer in proportion. The fertilizer regulating solution/fertilizer obtained can be applied as a base fertilizer or a top dressing, as a water-soluble fertilizer to irrigate the soil, or as a foliar fertilizer to be sprayed on leaves of plants.

(3) The soil conditioner obtained by the present invention can be applied directly as a soil conditioner; and can also be mixed with a finished product of a soil conditioner, a chemical fertilizer or an organic fertilizer to prepare a compound conditioner; or mixed with a soil conditioner raw material, an inorganic fertilizer raw material, a fertilizer auxiliary material, etc. in appropriate proportion to prepare a compound conditioner (compound fertilizer), and form a compound conditioner with multiple raw materials and multiple formulas and based on a wasted gulonic acid mother solution regulating solution, so as to meet the double needs of improving soil and increasing Vc content of crops for different regions, different soil types and different crops.

5. The present invention uses the wasted gulonic acid mother solution as the fertilizer raw material, which solves the problem of resource utilization of the wasted mother solution, provides a high-quality organic matter raw material for the production of the fertilizer and the soil conditioner, turns waste into treasure.

+

Detailed description of the present invention is further illustrated below in combination with examples. It shall be noted that the detailed description described herein is only used to illustrate and explain the present invention, not limited to the present invention.

The regulating solution of the present invention uses a wasted gulonic acid mother solution as a raw material, and the fertilizer regulating solution (used for preparing the fertilizer) with a pH of 3.0-9.0 and the soil conditioner regulating solution (used for preparing the soil conditioner) with a pH of 2.0-10.0 are obtained after the acid-base reaction between the wasted gulonic acid mother solution and the alkaline reagents. The fertilizer regulating solution and the soil conditioner regulating solution here are collectively referred to as the regulating solution.

The fertilizer regulating solution can be applied alone, or applied as a compound fertilizer after being mixed with a chemical fertilizer and a biological fertilizer in proportion, or applied after being mixed with a chemical fertilizer raw material and a fertilizer auxiliary material in proportion to prepare a compound fertilizer.

The soil conditioner is obtained by mixing the soil conditioner regulating solution with plant fibers at a mass ratio of 1:0-0.8, drying the materials at a low temperature, and crushing the materials. The soil conditioner can be applied alone, or mixed with the products or raw materials of another soil conditioner, a chemical fertilizer and a biological fertilizer in certain proportion to prepare a compound conditioner and be applied.

The fertilizer regulating solution can be applied alone, or applied as a compound fertilizer after being mixed with the products or raw materials of another chemical fertilizer, an organic fertilizer and a biological fertilizer in certain proportion, and can also be applied as a base fertilizer or a top dressing, as a water-soluble fertilizer to irrigate the soil, or as a foliar fertilizer to be sprayed on leaves. The soil conditioner regulating solution can be directly used as the soil conditioner and applied alone, or mixed with the products or raw materials of another soil conditioner, a chemical fertilizer, an organic fertilizer and a biological fertilizer in certain proportion to prepare a compound conditioner and be applied, so as to increase the nutrients of obstacle soils, improve soil acidity and alkalinity, and regulate soil microbial community structure, etc. The present invention provides a raw material riched in 2-keto-L-gulonic acid and organic acids for the fertilizer and the soil conditioner, which can significantly increase Vc content and quality of plants, and solves the problem of resource treatment of the wasted gulonic acid mother solution discharged in the industrial production of Vc at the same time.

### 1. EMBODIMENTS OF FERTILIZER REGULATING SOLUTION AND FERTILIZER PREPARATION

### Embodiment 1

A residual liquid of a Vc biological fermentation broth after various procedures such as ultrafiltration separation, ion exchange, triple effect evaporation, concentration and gulonic acid crystallization (i.e., a wasted gulonic acid mother solution) is used as a raw material;

15 L of 30 wt % sodium hydroxide solution is slowly added into a 100 L plastic drum containing 50 L of the wasted gulonic acid mother solution (the specific gravity of mother solution is 1.32, and the content of 2-keto-L-gulonic acid is 25 wt %), thorough stirring is carried out during addition to prevent local overheating, solution temperature is ensured to be not higher than 60° C. during reaction, and the pH of the reaction system is regulated to 3.0, thus a fertilizer regulating solution product 1 is obtained.

### Embodiment 2

A residual liquid of a Vc biological fermentation broth after various procedures such as ultrafiltration separation, ion exchange, triple effect evaporation, concentration and 2-keto-L-gulonic acid crystallization (i.e., a wasted gulonic acid mother solution) is used as a raw material.

17 L of 48 wt % potassium hydroxide solution is slowly added into a 100 L plastic drum containing 50 L of the wasted gulonic acid mother solution (the specific gravity of mother solution is 1.25, and the content of 2-keto-L-gulonic acid is 18 wt %), thorough stirring is carried out during addition to prevent local overheating, solution temperature is ensured to be not higher than 60° C. during reaction, and the pH of the reaction system is regulated to 4.0, thus a fertilizer regulating solution product 2 is obtained.

### Embodiment 3

A residual liquid of a Vc biological fermentation broth after various procedures such as ultrafiltration separation, ion exchange, triple effect evaporation, concentration and 2-keto-L-gulonic acid crystallization (i.e., a wasted gulonic acid mother solution) is used as a raw material.

18 L of 25 wt % ammonia solution is slowly added into a 100 L plastic drum containing 50 L of the wasted gulonic acid mother solution (the specific gravity of mother solution is 1.38, and the content of 2-keto-L-gulonic acid is 32 wt %), thorough stirring is carried out during addition to prevent local overheating, solution temperature is ensured to be not higher than 60° C. during reaction, and the pH of the reaction system is regulated to 6.0, thus a fertilizer regulating solution product 3 is obtained.

### Embodiment 4

A residual liquid of a Vc biological fermentation broth after various procedures such as ultrafiltration separation, ion exchange, triple effect evaporation, concentration and 2-keto-L-gulonic acid crystallization (i.e., a wasted gulonic acid mother solution) is used as a raw material.

27 L of 40 wt % potassium hydroxide solution is slowly added into a 100 L plastic drum containing 50 L of the wasted gulonic acid mother solution (the specific gravity of mother solution is 1.32, and the content of 2-keto-L-gulonic acid is 25 wt %), then 8 L of 10 wt % ammonia solution is slowly added into the plastic drum, thorough stirring is carried out during addition to prevent local overheating, solution temperature is ensured to be not higher than 60° C. during reaction, and the pH of the reaction system is regulated to 8.8, thus a fertilizer regulating solution product 4 is obtained.

### Embodiment 5

A residual liquid of a Vc biological fermentation broth after various procedures such as ultrafiltration separation, ion exchange, triple effect evaporation, concentration and 2-keto-L-gulonic acid crystallization (i.e., a wasted gulonic acid mother solution) is used as a raw material;

27 L of 40 wt % potassium hydroxide solution is slowly added into a 100 L plastic drum containing 50 L of the wasted gulonic acid mother solution (the specific gravity of mother solution is 1.40, and the content of 2-keto-L-gulonic acid is 35 wt %), then 5 L of 10 wt % ammonia solution is slowly added into the plastic drum, thorough stirring is carried out during addition to prevent local overheating, solution temperature is ensured to be not higher than 60° C. during reaction, and the pH of the reaction system is regulated to 7.0, thus a fertilizer regulating solution product 5 is obtained;

### 2. PREPARATION OF COMPOUND FERTILIZER BY MIXING REGULATING SOLUTION OBTAINED BY ABOVE EMBODIMENT WITH INORGANIC FERTILIZER RAW MATERIAL

### Embodiment 6

A residual liquid of a Vc biological fermentation broth after various procedures such as ultrafiltration separation, ion exchange, triple effect evaporation, concentration and 2-keto-L-gulonic acid crystallization (i.e., a wasted gulonic acid mother solution) is used as a raw material;

15 L of 30 wt % sodium hydroxide solution is slowly added into a 100 L plastic drum containing 50 L of the wasted gulonic acid mother solution (the specific gravity of mother solution is 1.32, and the content of 2-keto-L-gulonic acid is 25 wt %), thorough stirring is carried out during addition to prevent local overheating, solution temperature is ensured to be not higher than 60° C. during reaction, and the pH of the reaction system is regulated to 3.0, thus a fertilizer regulating solution is obtained.

10 L of the fertilizer regulating solution is mixed with inorganic fertilizers at a mass ratio of 1:0.46, the mixture is dried in an oven at 50° C. after thorough mixing until the moisture content drops to 10%, and a solid fertilizer product A is obtained, i.e., an organic-inorganic compound fertilizer is obtained.

The inorganic fertilizers are 3400 g of urea, 900 g of monoammonium phosphate and 1780 g of potassium chloride.

The compound fertilizer obtained above is tested, the ratio of N—P₂O₅—K₂O is 15-5-10, the total nutrient is ≥30%, and the organic matter content is ≥30%, which conforms to the national standard for organic-inorganic compound fertilizers of China (GB18877-2009).

### Embodiment 7

Preparation of Compound Fertilizer by Mixing Regulating Solution Obtained after Treatment by Embodiment 2 with Organic Fertilizer:

A residual liquid of a Vc biological fermentation broth after various procedures such as ultrafiltration separation, ion exchange, triple effect evaporation, concentration and 2-keto-L-gulonic acid crystallization (i.e., a wasted gulonic acid mother solution) is used as a raw material;

17 L of 48 wt % potassium hydroxide solution is slowly added into a 100 L plastic drum containing 50 L of the wasted gulonic acid mother solution (the specific gravity of mother solution is 1.25, and the content of 2-keto-L-gulonic acid is 18 wt %), thorough stirring is carried out during addition to prevent local overheating, solution temperature is ensured to be not higher than 60° C. during reaction, and the pH of the reaction system is regulated to 4.0, thus a fertilizer regulating solution product 2 is obtained;

The fertilizer regulating solution is mixed with an organic fertilizer at a mass ratio of 1:5, the mixture is dried in an oven at 60° C. after thorough mixing until the moisture content drops to 25%, and a solid organic fertilizer product is obtained, i.e., a compound fertilizer is obtained.

The organic fertilizer is a commercially available organic fertilizer using high-quality organic raw materials such as biogas residue, tobacco mud, starch residue, sesame cake, mushroom residue, livestock and poultry manure, and bone meal. Among the main components: the organic matter is ≥45%, N+P₂O₅+K₂O≥12%, the pH is 6.0-8.0, and the moisture is ≤30%.

The compound fertilizer obtained above is tested, the ratio of N—P₂O₅—K₂O is 5-3-3, the total nutrient is ≥10%, and the organic matter content is ≥45%, which conforms to the national standard for organic fertilizers of China (NY525-2009).

### Embodiment 8

Preparation of Compound Fertilizer by Mixing Regulating Solution Obtained after Treatment by Embodiment 3 with Water-Soluble Fertilizer:

A residual liquid of a Vc biological fermentation broth after various procedures such as ultrafiltration separation, ion exchange, triple effect evaporation, concentration and 2-keto-L-gulonic acid crystallization (i.e., a wasted gulonic acid mother solution) is used as a raw material;

18 L of 25 wt % ammonia solution is slowly added into a 100 L plastic drum containing 50 L of the wasted gulonic acid mother solution (the specific gravity of mother solution is 1.38, and the content of 2-keto-L-gulonic acid is 32 wt %), thorough stirring is carried out during addition to prevent local overheating, solution temperature is ensured to be not higher than 60° C. during reaction, and the pH of the reaction system is regulated to 6.0, thus a fertilizer regulating solution is obtained.

The fertilizer regulating solution is mixed with a water-soluble fertilizer at a mass ratio of 1:4, the mixture is dried in an oven at 55° C. after thorough mixing until the moisture content drops to 10%, and a solid fertilizer product is obtained, i.e., an organic-inorganic compound fertilizer is obtained.

The water-soluble fertilizer is a commercially available product, and the ratio of N—P₂O₅—K₂O is 20-20-20.

The compound fertilizer obtained above is tested, the ratio of N—P₂O₅—K₂O is 18-18-18, the total nutrient is ≥50%, the organic matter content is ≥5%, and the moisture content is ≤12%.

### Embodiment 9

Preparation of Compound Fertilizer by Mixing Regulating Solution Obtained by Embodiment 5 with Inorganic Fertilizer Raw Material and Fertilizer Auxiliary Material:

A residual liquid of a Vc biological fermentation broth after various procedures such as ultrafiltration separation, ion exchange, triple effect evaporation, concentration and 2-keto-L-gulonic acid crystallization (i.e., a wasted gulonic acid mother solution) is used as a raw material;

27 L of 40% potassium hydroxide solution is slowly added into a 100 L plastic drum containing 50 L of the wasted gulonic acid mother solution (the specific gravity of mother solution is 1.40, and the content of 2-keto-L-gulonic acid is 35 wt %), then 5 L of 10 wt % ammonia solution is slowly added into the plastic drum, thorough stirring is carried out during addition to prevent local overheating, solution temperature is ensured to be not higher than 60° C. during reaction, and the pH of the reaction system is regulated to 7.0, thus a fertilizer regulating solution product 5 is obtained;

10 L of the fertilizer regulating solution is mixed with an inorganic fertilizer raw material and a fertilizer auxiliary material at a mass ratio of 1:5:0.5, and a liquid organic fertilizer product is obtained after thorough mixing, i.e., a compound fertilizer is obtained.

The inorganic fertilizer raw material is composed of 21 kg of urea, 16 kg of monoammonium phosphate, 21 kg of potassium nitrate, 5 kg of magnesium sulphate, 6 kg of superphosphate, 0.2 kg of manganese chloride tetrahydrate, 0.2 kg of ferrous sulphate, 0.2 kg of zinc sulphate, 0.2 kg of ammonium molybdate dihydrate and 0.2 kg of copper sulphate pentahydrate.

The compound fertilizer obtained above is tested, the ratio of N—P₂O₅—K₂O is 11-11-11, the total nutrient is ≥30%, and the organic matter content is ≥5%.

### 2. EMBODIMENTS OF SOIL CONDITIONER REGULATING SOLUTION AND SOIL CONDITIONER PREPARATION

### Embodiment 10

A residual liquid of a Vc biological fermentation broth after various procedures such as ultrafiltration separation, ion exchange, concentration and 2-keto-L-gulonic acid crystallization (i.e., a gulonic acid mother solution) is used as a raw material;

19 L of 40 wt % potassium hydroxide solution is slowly added into a 100 L plastic drum containing 50 L of the gulonic acid mother solution (the specific gravity of mother solution is 1.34, and the content of 2-keto-L-gulonic acid is 28 wt %), thorough stirring is carried out during addition to prevent local overheating, reaction solution temperature is kept to be not higher than 60° C. during reaction, reaction time is 20 minutes, and the pH of a regulating solution obtained after regulation is 3.0. Further, 80 kg of the regulating solution is thoroughly mixed with 50 kg of 50-mesh rice hull powder for 10 minutes, the materials after mixing are dried in an oven at 60° C. for 4 hours, the moisture content of the materials is 20%, and the materials are finally crushed by a crusher and sieved by a 20-mesh screen, thus a soil conditioner product 1 is obtained.

### Embodiment 11

A residual liquid of a Vc biological fermentation broth after various procedures such as ultrafiltration separation, ion exchange, concentration and gulonic acid crystallization (i.e., a gulonic acid mother solution) is used as a raw material;

20 L of 25 wt % ammonia solution is slowly added into a 100 L plastic drum containing 50 L of the gulonic acid mother solution (the specific gravity of mother solution is 1.32, and the content of gulonic acid is 22 wt %), thorough stirring is carried out during addition to prevent local overheating, solution temperature is ensured to be not higher than 60° C. during reaction, reaction time is 30 minutes, and the pH of a regulating solution obtained after regulation is 5.9. Further, 80 kg of the regulating solution is thoroughly mixed with 20 kg of 100-mesh straw powder for 20 minutes, the materials after mixing are dried in an oven at 50° C. for 8 hours, the moisture content of the materials is 17%, and the materials are finally crushed by a crusher and sieved by a 20-mesh screen, thus a soil conditioner product 2 is obtained.

### Embodiment 12

A residual liquid of a Vc biological fermentation broth after various procedures such as ultrafiltration separation, ion exchange, concentration and 2-keto-L-gulonic acid crystallization (i.e., a gulonic acid mother solution) is used as a raw material;

10 L of 25 wt % ammonia solution is slowly added into a 100 L plastic drum containing 50 L of the gulonic acid mother solution (the specific gravity of mother solution is 1.40, and the content of 2-keto-L-gulonic acid is 33 wt %), then 9.5 kg of calcium hydroxide is slowly added, thorough stirring is carried out during addition to prevent local overheating, solution temperature is ensured to be not higher than 60° C. during reaction, reaction time is 60 minutes, and the pH of a regulating solution obtained after regulation is 7.0. Further, 80 kg of the regulating solution is thoroughly mixed with 30 kg of 100-mesh bagasse powder for 20 minutes, the materials after mixing are dried in an oven at 55° C. for 6 hours, the moisture content of the materials is 16%, and the materials are finally crushed by a crusher and sieved by a 20-mesh screen, thus a soil conditioner product 3 is obtained.

### Embodiment 13

A residual liquid of a Vc biological fermentation broth after various procedures such as ultrafiltration separation, ion exchange, concentration and 2-keto-L-gulonic acid crystallization (i.e., a gulonic acid mother solution) is used as a raw material;

12 kg of solid potassium hydroxide is slowly added into a 100 L plastic drum containing 50 L of the gulonic acid mother solution (the specific gravity of mother solution is 1.25, and the content of 2-keto-L-gulonic acid is 18 wt %), then 4.6 kg of calcium hydroxide is slowly added, thorough stirring is carried out during addition to prevent local overheating, solution temperature is kept to be not higher than 60° C. during reaction, reaction time is 60 minutes, and the pH of a regulating solution obtained after regulation is 8.8. Further, 70 kg of the regulating solution is thoroughly mixed with 60 kg of 20-mesh wheat bran powder for 20 minutes, the materials after mixing are dried in an oven at 50° C. for 5 hours, the moisture content of the materials is 14%, and the materials are finally crushed by a crusher and sieved by a 20-mesh screen, thus a soil conditioner product 4 is obtained.

### Embodiment 14

A residual liquid of a Vc biological fermentation broth after various procedures such as ultrafiltration separation, ion exchange, concentration and 2-keto-L-gulonic acid crystallization (i.e., a gulonic acid mother solution) is used as a raw material;

5 L of 25 wt % ammonia solution is slowly added into a 100 L plastic drum containing 50 L of the gulonic acid mother solution (the specific gravity of mother solution is 1.30, and the content of 2-keto-L-gulonic acid is 24 wt %), thorough stirring is carried out during addition to prevent local overheating, solution temperature is ensured to be not higher than 60° C. during reaction, reaction time is 10 minutes, and the pH of a regulating solution obtained after regulation is 2.0. Further, 60 kg of the regulating solution is thoroughly mixed with 5 kg of 200-mesh rice hull powder for 20 minutes, and after bottling, the regulating solution becomes a soil conditioner product 5 (liquid type).

### Embodiment 15

A residual liquid of a Vc biological fermentation broth after various procedures such as ultrafiltration separation, ion exchange, concentration and 2-keto-L-gulonic acid crystallization (i.e., a gulonic acid mother solution) is used as a raw material; the specific gravity of the mother solution is 1.35, and the content of 2-keto-L-gulonic acid is 23 wt %. On the other hand, for a 2-keto-L-gulonic acid solution, the content of 2-keto-L-gulonic acid is 23 wt %, wherein the 2-keto-L-gulonic acid is an industrial product. The wasted gulonic acid mother solution or/and 2-keto-L-gulonic acid solution can be directly used as a regulating solution. The two are mixed at a volume ratio of 1:0.5, thus a soil conditioner product 6 (liquid type) is obtained.

### Embodiment 16

A commercially available 2-keto-L-gulonic acid product (the content of 2-keto-L-gulonic acid is ≥95%) is bought, and 1000 g of the product is dissolved in 4000 g of tap water. The solution is added with 1.6 L of 25% ammonia solution, thorough stirring is carried out during addition to prevent local overheating, solution temperature is ensured to be not higher than 60° C. during reaction, reaction time is 10 minutes, and the pH of a regulating solution obtained after regulation is 6.2. 5 kg of the regulating solution is mixed with 4 kg of peanut hull powder, the materials after mixing are dried in an oven at 55° C. for 10 hours, and the moisture content of the materials is 19%. The materials are finally crushed and sieved by a 50-mesh screen, thus a soil conditioner product 7 is obtained.

### 3. PREPARATION OF COMPOUND CONDITIONER BY MIXING ABOVE SOIL CONDITIONER PRODUCTS WITH SOIL CONDITIONER RAW MATERIALS, INORGANIC FERTILIZER RAW MATERIAL, COMMERCIALLY AVAILABLE SOIL CONDITIONER, INORGANIC FERTILIZER AND ORGANIC FERTILIZER PRODUCT

### Embodiment 17

Preparation of Compound Conditioner by Mixing Above Soil Conditioner Products with Soil Conditioner Raw Material, Inorganic Fertilizer Raw Material, Commercially Available Soil Conditioner, Inorganic Fertilizer and Organic Fertilizer Product.

The soil conditioner product 1 is mixed with a commercially available chemical source soil conditioner product at a mass ratio of 1:1, and the mixture is crushed and sieved by a 20-mesh screen, thus a compound conditioner product 1 is obtained.

The soil conditioner product 3 is mixed with a commercially available organic source soil conditioner product at a mass ratio of 1:10, and the mixture is crushed and sieved by a 50-mesh screen, thus a compound conditioner product 2 is obtained.

The soil conditioner product 4 is mixed with a commercially available mineral source soil conditioner product at a mass ratio of 1:30, and the mixture is crushed and sieved by a 50-mesh screen, thus a compound conditioner product 3 is obtained.

The soil conditioner product 2 is mixed with a commercially available soil water-keeping absorbent polymer product at a mass ratio of 1:50, and the mixture is sieved by a 20-mesh screen, thus a compound conditioner product 4 is obtained.

The soil conditioner product 3 is thoroughly mixed with a commercially available organic fertilizer (using high-quality organic raw materials such as biogas residue, tobacco mud, starch residue, sesame cake, mushroom residue, livestock and poultry manure, and bone meal. Among the main components: the organic matter is ≥45%, N+P₂O₅+K₂O≥12%, the pH is 6.0-8.0, and the moisture is ≤30%.) at a mass ratio of 1:2, and the mixture is crushed and sieved by a 20-mesh screen, thus a compound conditioner product 5 is obtained.

The soil conditioner product 3 is thoroughly mixed with a commercially available inorganic nitrogenous fertilizer (urea), phosphate fertilizer (calcium superphosphate), potassium fertilizer (potassium chloride), compound fertilizer (monoammonium phosphate) and secondary element fertilizer (magnesium potassium chloride) at a mass ratio of 1:20:10:10:5:5, and the mixture is crushed and sieved by a 20-mesh screen, thus a compound conditioner product 6 is obtained.

The soil conditioner product 2 is mixed with an inorganic fertilizer raw material at a mass ratio of 1:5, and a compound conditioner product 7 is obtained after thorough mixing. The inorganic fertilizer raw material is a mixture of the following raw materials and is sieved by a 20-mesh screen: 42 kg of urea, 32 kg of monoammonium phosphate, 21 kg of potassium nitrate, 5 kg of magnesium sulphate, 6 kg of superphosphate, 0.2 kg of manganese chloride tetrahydrate, 0.2 kg of ferrous sulphate and 0.2 kg of zinc sulphate.

The soil conditioner product 1 is mixed with a soil conditioner raw material at a mass ratio of 1:9, and a compound conditioner product 8 is obtained after thorough mixing. The soil conditioner raw material is a mixture of the following raw materials and is sieved by a 50-mesh screen: 10 kg of bentonite, 10 kg of desulfuration gypsum and 5 kg of polyacrylamide.

The soil conditioner product 3 is mixed with an organic and inorganic fertilizer raw material at a mass ratio of 1:20, and a compound conditioner product 9 is obtained after thorough mixing. The organic and inorganic fertilizer raw material is a mixture of the following materials and is sieved by a 20-mesh screen: 0.5 kg of humic acid, 5 kg of rotten cow dung, 5 kg of urea and 2.5 kg of potassium dihydrogen phosphate.

### Application Example 1

Experiment of Increasing Vc Content of Pakchoi by Using Fertilizer Regulating Solution Product 1 in Embodiment 1 Mentioned Above:

1.5 kg of soil is put in a plastic pot (15 cm in height×20 cm in diameter). Two groups of treatments are set up: (1) potted plants applied with the fertilizer regulating solution product 1 (a treatment group); and (2) potted plants treated by tap water (a control group). 20 pakchoi seeds of the similar size are evenly scattered in each pot of soil. When the pakchoi sprouts to a length of 2 cm, the pakchoi seedlings in each pot of soil are thinned to 10 plants. During the cultivation of the pakchoi, each pot in the treatment group is applied with 75 ml of fertilizer regulating solution product diluent (i.e., the fertilizer regulating solution product 1 diluted by 250 times), and the diluent is applied twice a week for a total of 10 times; while the control group is applied with tap water, and the other conditions are the same. After 70 days of pot experiment, the pakchoi in each pot are harvested, washed, dried and weighed respectively. The Vc content of the pakchoi is determined after the above-ground part is crushed evenly. The Vc content is determined by a 2,6-dichlorophenol indophenol titration method. The results show that the yield of the pakchoi in the treatment group is significantly increased (from 9.74 g to 12.48 g per pot), with an increasing amplitude of 28.13%. The Vc content is increased by 55.6% (from 85.6 mg/kg to 133.2 mg/kg), and the difference is extremely significant. This indicates that the quality of the pakchoi is significantly improved under the effect of the wasted gulonic acid mother solution.

### Application Example 2

Experiment of Increasing Vc Content of Cucumber with Wasted Gulonic Acid Mother Solution by Using Fertilizer Regulating Solution Product 2 in Embodiment 2 Mentioned Above:

1.5 kg of soil is put in a plastic pot (15 cm in height×20 cm in diameter). Three groups of treatments are set up: (1) potted plants of cucumber treated by the fertilizer regulating solution product 2 (a treatment group 1); (2) potted plants of cucumber treated by tap water (a control group); and (3) potted plants of cucumber treated by 2-keto-L-gulonic acid solution (a treatment group 2). Four cucumber seeds of the similar size are evenly scattered in each pot. When the cucumber sprouts to a length of 2 cm, the cucumber seedlings in each pot of soil are thinned to 2 plants. During cultivation, each pot in the treatment group 1 is applied with the regulating solution product 2 diluted by 300 times, 200 ml of diluent is applied each time, and the diluent is applied twice a week for a total of 10 times; each pot in the treatment group treated by 2-keto-L-gulonic acid solution is applied with 2-keto-L-gulonic acid solution diluted by 300 times (the content of 2-keto-L-gulonic acid is 30 wt %), 200 ml of diluent is applied each time, and the diluent is applied twice a week for a total of 10 times; while the control group is applied with tap water, and the other conditions are the same. After 60 days of pot experiment, the cucumber in each pot are harvested, washed, dried and weighed respectively. The Vc content of the cucumber is determined after being sampled and crushed evenly. The Vc content is determined by a 2,6-dichlorophenol indophenol titration method.

The results show that, compared with the control group, the yield of the cucumber in the treatment group 1 is significantly increased, with an increasing amplitude of 10.5%, and the Vc content is significantly increased by 20.1%; however, no significant difference is found between the Vc content of the cucumber in the treatment group 1 and that in the treatment group 2, indicating that 2-keto-L-gulonic acid can significantly promote the increase of Vc content of cucumber.

### Application Example 3

Experiment of Increasing Vc Content of Apple by Using Fertilizer Regulating Solution Product 3 Obtained in Embodiment 3 Mentioned Above:

Three groups of treatments are set up: (1) potted plants treated by the fertilizer regulating solution product 3 (a treatment group 1); (2) potted plants treated by tap water (a control group); and (3) potted plants treated by 2-keto-L-gulonic acid solution (a treatment group 2). Four-year-old apple trees are selected, with five trees in each treatment. After blossoming, each tree in the treatment group 1 is applied with wasted gulonic acid mother solution diluted by 400 times, 50 L of diluent is applied each time, and the diluent is applied once a month for a total of 5 times; each tree in the treatment group treated by 2-keto-L-gulonic acid solution is applied with gulonic acid solution diluted by 400 times (the content of 2-keto-L-gulonic acid is 25 wt %), 50 L of diluent is applied each time, and the diluent is applied once a month for a total of 5 times; while the control group is applied with tap water, and the other conditions are the same. After five months of field experiment, apples in each treatment group are harvested and weighed, and Vc content is determined. The Vc content is determined by a 2,6-dichlorophenol indophenol titration method.

The results show that, compared with the control group, the fruit weight of the apples in the treatment group 1 is increased, with an average increase of 16 g in weight, and the Vc content is significantly increased by 10.1%; however, no significant difference is found between the Vc content of the apples in the treatment group 1 and that in the treatment group 2, indicating that 2-keto-L-gulonic acid can significantly promote the increase of Vc content of apple.

### Application Example 4

### Experiment of Applying Regulating Solution Produced by Wasted Gulonic Acid Mother Solution to Tomato.

Experiment method: two treatments are set up, and each treatment is repeated for three times. Each plot covers an area of 4 square meters, and 80 plants of tomato are planted. In treatment 1, conventional fertilization is carried out with pure inorganic fertilizers; 20 kg of urea, 30 kg of calcium magnesium phosphate and 15 kg of potassium chloride are applied per 666.7 m² as base fertilizers; 60% of the nitrogenous fertilizer is used as a base fertilizer, and 40% is used as a top dressing. In treatment 2, based on the conventional fertilization of treatment 1, the fertilizer regulating solution product 5 of embodiment 5 diluted by 400 times is applied by irrigation every 11th day after tomato seedling transplantation. The Vc content of fruits is determined after the fruits are ripe.

The results show that the regulating solution (the regulating solution product 5 of embodiment 5) promotes the growth of tomato and increases the Vc content of tomato by 12%.

### Application Example 5

### Experiment of Spraying Regulating Solution Produced by Wasted Gulonic Acid Mother Solution on Apple as Foliar Fertilizer.

Experiment method: two treatments are set up, with 10 four-year-old apple trees in each treatment. In treatment 1, conventional fertilization of the trees is carried out; 80 kg of urea, 30 kg of calcium magnesium phosphate and 60 kg of potassium sulphate are applied per mu; 50% of the nitrogenous fertilizer is used as a base fertilizer, and 40% is used as a top dressing; 50% of the potassium fertilizer is used as a base fertilizer, and 50% is used as a top dressing. In treatment 2, based on the conventional fertilization of treatment 1, the fertilizer regulating solution product 5 of embodiment 5 diluted by 600 times is sprayed on leaves every 11th day during the full bearing period of the apple. As a control, in treatment 1, an equal amount of tap water is sprayed on leaves. The Vc content of fruits is determined after the fruits are ripe.

The results show that the leaves sprayed with the regulating solution (the fertilizer regulating solution product 5 of embodiment 5) are smooth and dark green, and the Vc content of the apples is increased by 10%.

### Application Example 6

Experiment of Applying Compound Fertilizer Prepared by Mixing Regulating Solution Produced by Wasted Gulonic Acid Mother Solution with Inorganic Fertilizer Raw Material to Garden Chrysanthemum.

Experiment method: two treatments are set up, and the sown area of garden chrysanthemum in each treatment is 3 m×3 m. Treatment 1 is a control group, and treatment 2 is a compound fertilizer (the compound fertilizer of embodiment 9) group based on wasted gulonic acid mother solution. The chemical fertilizers of the two groups are exactly the same in components and proportions, and the application method is to apply after being dissolved in water and diluted by 200 times. The Vc content of the stem is determined after the garden chrysanthemum is ripe.

The results show that the garden chrysanthemum of treatment 2 grows fast, and the Vc content of the stem is increased by 18% on average.

### Application Example 7

### Experiment of Directly Applying Regulating Solution Produced by Wasted Gulonic Acid Mother Solution to Rice.

Experiment method: two treatments are set up, the planting area of rice in each treatment is 3 m×3 m, and each treatment is repeated for five times. Treatment 1 is a control group, treatment 2 is a regulating solution group based on wasted gulonic acid mother solution, and the regulating solution used is the fertilizer regulating solution product 2 of embodiment 2. The organic and inorganic fertilizers applied in the two treatment groups are exactly the same in components, proportions, application time and application method. In treatment 2, the regulating solution is diluted with water by 200 times and applied every 21th day during the growing period of rice, and 10 L of the regulating solution is applied per mu. The Vc content of threshed rice is determined after the rice is harvested.

The results show that the rice of treatment 2 has good growth and lodging resistance, and the Vc content is increased by 11% on average.

### Application Example 8

Experiment of Planting Pakchoi in Saline-Alkali Soil and Increasing Yield and Vc Content of Pakchoi by Using Soil Conditioner Product 1 in Above Embodiment:

The soil for experiment is a loamy saline-alkali soil (with a pH of 9.2, an alkalization degree of 30%, and a salt content of 0.6%), and each plastic pot for pot experiment is 15 cm in height×20 cm in diameter. Two groups of treatments are set up: (1) potted plants applied with the soil conditioner product 1 (a treatment group); 150 kg of the conditioner and 1.35 kg of the saline-alkali soil are thoroughly mixed and put into each pot; and (2) potted plants not applied with the soil conditioner (a control group). Each treatment includes five pots. 25 pakchoi seeds of the similar size are evenly scattered in each pot of soil. When the pakchoi sprouts to a length of 2 cm, the pakchoi seedlings in each pot of soil are thinned to 10 plants. During the cultivation of the pakchoi, each treatment is irrigated twice a week for a total of 20 times. Other irrigation and fertilization conditions are the same. After 70 days of pot experiment, the pakchoi in each pot are harvested, washed, dried and weighed respectively. The Vc content of the pakchoi is determined after the above-ground part is crushed evenly. The Vc content is determined by a 2,6-dichlorophenol indophenol titration method.

The results show that the soil conditioner product decreases the pH value of the soil (from 9.2 in the control group to 8.9 in the treatment group), decreases the alkalization degree of the soil to 16.0% (with a decreasing amplitude of 46.7%), decreases salt content to 0.3% (with a decreasing amplitude of 50%), increases the number of soil bacteria by 35.8%, significantly increases the yield of the pakchoi (from 9.20 g (fresh weight) per pot in the control group to 13.44 g (fresh weight), with an increasing amplitude of 46.1%), and significantly increases the Vc content (from 437.0 mg/kg (fresh weight) to 634.0 mg/kg (fresh weight), with an increasing amplitude of 45.1%). The above results indicate that, under the effect of the soil conditioner containing wasted gulonic acid mother solution, the salinity and alkalinity of the soil is decreased, the number of soil microorganisms is increased, and the yield and quality of the pakchoi are significantly improved.

### Application Example 9

Experiment of Planting Cucumber in Acidified and Compacted Soil of Vegetable Greenhouse and Increasing Vc Content of Cucumber by Using Soil Conditioner Product 4 in Above Embodiment:

The soil for experiment is the acidified and compacted soil of a vegetable greenhouse, with a pH of 5.3 and a poor air permeability. Each plastic pot for pot experiment is 20 cm in height×30 cm in diameter. Two groups of treatments are set up: (1) potted plants applied with the soil conditioner product 4 in the above embodiment (a treatment group); 100 g of the soil conditioner and 2.4 kg of the acidified soil of a vegetable greenhouse are added into each pot and mixed well; and (2) control group potted plants (a control group); 2.5 kg degraded soil of a vegetable greenhouse is added into each pot. Each treatment includes five pots. Four cucumber seeds of the similar size are evenly scattered in each pot of soil. When the cucumber sprouts to a length of 2 cm, the cucumber seedlings in each pot are thinned to 2 plants. During cultivation, the irrigation and fertilization conditions of the treatments are the same. After 60 days of pot experiment, the cucumber in each pot are harvested, washed, dried and weighed respectively. The Vc content of the cucumber is determined after being sampled and crushed. The Vc content is determined by a 2,6-dichlorophenol indophenol titration method.

The results show that, compared with the control group, the pH of the soil in the treatment group is increased to 5.6, soil exchangeable acid is significantly decreased (from 5.7 c mol/kg to 4.8 c mol/kg), and the acidity of the soil is effectively relieved. The volume weight of the soil is decreased by 8.9% (1.218 g/cm³ for the control group, and 1.109 g/cm³ for the treatment group), the porosity of the soil is increased by 7.3% (the porosity of the control group is 49.3%, and that of the treatment group is 52.9%), the proportion of soil macroaggregates is increased by 10.6% (the proportion of soil macroaggregates of the control group is 61.1%, and that of the treatment group 67.6%), the yield of the cucumber is significantly increased, with an increasing amplitude of 14.3%, the average Vc content of cucumber fruits is increased from 54 mg/kg (fresh weight) to 66 mg/kg (fresh weight), which is significantly increased by 22.2%, and the difference is extremely significant in statistics.

### Application Example 10

Experiment of Planting Green Pepper in Succession Cropping Agricultural Soil and Increasing Vc Content of Green Pepper by Using Soil Conditioner Product 2 in Above Embodiment:

The soil for experiment is green pepper succession cropping agricultural soil, and each plastic pot for pot experiment is 15 cm in height×20 cm in diameter. Two groups of treatments are set up: (1) potted plants applied with the soil conditioner product 2 in the above embodiment (a treatment group); 100 g of the soil conditioner and 1.4 kg of the continuous cropping agricultural soil are added into each pot and mixed well; and (2) control group potted plants (a control group); 1.5 kg of the continuous cropping agricultural soil is added into each pot. Each treatment includes five pots. Three green pepper seedlings are planted in each pot. The irrigation and fertilization managements of the treatments are completely consistent during the growing period of the green pepper.

After 80 days of pot experiment, the green pepper in each pot are harvested, washed, dried and weighed respectively. The Vc content of the green pepper is determined after being sampled and crushed. The Vc content is determined by a HPLC method.

The results show that, compared with the control group, no obvious succession cropping disease is found in the treatment group, the yield of the green pepper is significantly increased, with an increasing amplitude of 19.2%, the averaged Vc content of green pepper fruits is increased from 685 mg/kg (fresh weight) to 1023 mg/kg (fresh weight), which is significantly increased by 49.3%, and the difference is extremely significant in statistics.

### Application Example 11

### Experiment of Planting Tomato in Saline-Alkali Soil by Using Soil Conditioner Product 1 in Embodiment:

Experiment method: the soil for experiment is saline-alkali soil (with a pH of 9.40, an alkalization degree of 35%, and a salt content of 0.6%). Two treatments are set up, and each treatment is repeated for three times. Each plot covers an area of 4 square meters, and 60 plants of tomato are planted. In treatment 1, conventional fertilization is carried out with inorganic fertilizers; 20 kg of urea, 30 kg of calcium magnesium phosphate and 15 kg of potassium chloride are applied per 666.7 m² as base fertilizers; 60% of the nitrogenous fertilizer is used as a base fertilizer, and 40% is used as a top dressing fertilizer. In treatment 2, based on the conventional fertilization of treatment 1, the soil conditioner product 1 of the embodiment is applied before tomato seedling transplantation, and the application amount is 200 kg/666.7 m². The two treatments adopt the same irrigation and fertilization management except for applying the soil conditioner.

The results indicate that, after application, the soil conditioner (the soil conditioner product 1) decreases the pH value of the soil to 9.22, decreases the alkalization degree of the soil to 21% (with a decreasing amplitude of 40.0%), decreases salt content to 0.2% (with a decreasing amplitude of 66.6%), obviously improves the acidity and alkalinity of the saline-alkali soil, and increases the content of soil organic matters (the content is 1.4%, with an increasing amplitude of 9.5%) and the content of available phosphorus (with an increasing amplitude of 13.7%). In addition, the soil conditioner (the soil conditioner product 1) significantly promotes the growth of the tomato, increases the yield of the tomato by 8.0%, and increases the average Vc content of tomato fruits from 197 mg/kg (fresh weight) to 273 mg/kg (fresh weight), which is increased by 38.6%, and the difference is extremely significant in statistics.

### Application Example 12

### Experiment of Planting Garden Chrysanthemum in Acidified Soil of Vegetable Greenhouse by Using Soil Conditioner Product 4 in Embodiment:

Experiment method: the soil for experiment is an acidified soil of a vegetable greenhouse with a low organic matter content, serious soil compaction and acidification (the pH is 4.9), and a low crop yield. Two treatments are set up, and the sown area of garden chrysanthemum in each treatment is 3 m×3 m. Treatment 1 is a control group, treatment 2 is a treatment group applied with the soil conditioner, and each treatment is repeated for three times. Before the garden chrysanthemum is sown, 300 kg of the soil conditioner product 4 in embodiment 1 is applied to the treatment group per 666.7 m². Except for this, the irrigation and fertilization managements of the two groups are the same.

The results indicate that, after application, the soil conditioner product 4 increases the pH of the soil (from 4.9 to 5.5), significantly decreases soil exchangeable acid (from 6.2 c mol/kg to 5.5 c mol/kg), and effectively relieves the acidity of the soil. The volume weight of the soil is decreased by 9.7% (1.207 g/cm³ for the control group, and 1.090 g/cm³ for the treatment group), the porosity of the soil is increased by 6.1% (the porosity of the control group is 50.3%, and that of the treatment group is 52.7%), and the proportion of soil macroaggregates is increased by 12.8% (the proportion of soil macroaggregates of the control group is 66.3%, and that of the treatment group 74.8%), indicating that the amelioration of soil compaction is obvious. The roots and seedlings of the garden chrysanthemum in the treatment group are strong and prosperous, the yield per unit area is increased 11.0% compared with that of the control group, the average Vc content in stems of the treatment group is 244 mg/kg (fresh weight), which is increased by 43.5% compared with that of the control group (170 mg/kg (fresh weight)), and the difference is extremely significant in statistics, indicating that the conditioned soil improves the yield and quality of crops.

### Application Example 13

### Experiment of Planting Grape in Lean Soil by Using Soil Compound Conditioner Product 5 in Embodiment:

Experiment method: the soil for planting grape is lean soil with a low organic matter content (0.8%). Two treatments are set up, with 10 four-year-old grape vines in each treatment. In treatment 1, conventional fertilization of the grape vines is carried out; 60 kg of urea, 25 kg of calcium magnesium phosphate and 35 kg of potassium sulphate are applied per 666.7 m². In treatment 2, based on the conventional fertilization of treatment 1, 1 kg the soil compound conditioner product 5 in the above embodiment is applied to a hole 15-20 cm from the root of each vine respectively during the flowering period and full bearing period of the grape. The irrigation, fertilization and pesticide managements of the treatments are the same except for applying the conditioner. The Vc content of fruits is determined after the fruits are ripe.

The results show that, after application, the compound conditioner (the soil compound conditioner product 5) increases the content of organic matters in rhizospheric soil of the grape vines (by 7.5% compared with that of conventional fertilization), increases the number of bacteria in the rhizosphere soil by 34.0%, increases the content of available phosphorus by 9.3%, and increases the content of alkali-hydrolyzable nitrogen by 8.2%, indicating that the soil nutrient is effectively increased by applying the compound conditioner. The leaves of the grape vines in the treatment group applied with the conditioner are dark green, the fruits are sweeter, and the yield of the grape is increased by 8.0% on average. The Vc content of the grape is increased by 11.5% on average (the average Vc content of grape fruits in treatment 1 is 18.2 mg/kg, and that in treatment 2 is 20.3 mg/kg), and the difference is extremely significant in statistics.

### Application Example 14

### Experiment of Planting Apple in Sandy Soil by Using Soil Compound Conditioner Product 9 in Embodiment:

Experiment method: the soil for planting apple is sandy soil with a low organic matter content (0.3%). Two treatments are set up, with 10 four-year-old apple trees in each treatment. In treatment 1, conventional fertilization of the trees is carried out; 80 kg of urea, 30 kg of calcium magnesium phosphate and 60 kg of potassium sulphate are applied per 666.7 m²; 60% of the nitrogenous fertilizer is used as a base fertilizer, and 40% is used as a top dressing; 50% of the potassium fertilizer is used as a base fertilizer, and 50% is used as a top dressing. In treatment 2, based on the conventional fertilization of treatment 1, 2 kg the soil compound conditioner product 9 in the above embodiment is applied to a furrow 45-50 cm from the root of each tree respectively during the flowering period and full bearing period of the apple. The irrigation, fertilization and pesticide managements of the treatments are the same except for applying the conditioner. The Vc content of fruits is determined after the fruits are ripe.

The results show that, after application, the compound conditioner (the soil compound conditioner product 9) increases the content of organic matters in the soil under the tree canopy (by 18.9% compared with that of conventional fertilization), decreases the volume weight of the soil by 12.8% (1.420 g/cm³ for treatment 1, and 1.238 g/cm³ for treatment 2), increases the content of water-stable aggregates by 25.8% (36.3% for treatment 1, and 45.7% for treatment 2), and obviously improves the nutrient and soil physical structure of the sandy soil. The leaves of the apple trees in the treatment group applied with the compound conditioner are dark green, the fruits are more crisp and sweet, the average fruit weight is increased by 6.4% (215.0 g for treatment 1, and 228.8 g for treatment 2), the Vc content of the apple is increased by 18.0% on average (the average Vc content of the apple in treatment 1 is 38.0 mg/kg, and that in treatment 2 is 44.8 mg/kg), and the difference is extremely significant in statistics.

### Application Example 15

### Experiment of Planting Rice by Using Soil Conditioner Product 1 in Embodiment:

Experiment method: the experimental field is a paddy soil in northeast China. Two treatments are set up, the planting area of rice in each treatment is 3 m×3 m, and each treatment is repeated for five times. Treatment 1 is a control group, treatment 2 is a treatment group applied with the conditioner, and the conditioner used is the soil conditioner product 1 of the embodiment. The organic and inorganic fertilizers applied in the two treatment groups are exactly the same in components, proportions, application time and application method. In treatment 2, the soil conditioner product 1 is dissolved in water, diluted by 200 times and applied together with irrigation water every 26th day during the growing period of rice, and the application amount is 20 kg/666.7 m² each time. In treatment 1, the soil conditioner product 1 is replaced with an equal amount of water, and the dilution and application conditions are the same as those in treatment 2. The related indexes of soil and crop in different treatments are determined after the rice is harvested.

The results show that the content of available silicon in the soil of treatment 2 is 405 mg/kg, which is increased by 22.7% compared with the content of available silicon (330 mg/kg) in the soil of treatment 1 (the control group). The rice of treatment 2 has good growth, lodging resistance and no rice blast, the yield of the rice is increased by 7.4%, the average Vc content of hulled rice is increased from 6.34 mg/kg to 7.37 mg/kg, which is increased by 16.3%, and the difference is extremely significant in statistics.

### Application Example 16

### Experiment of Spraying Regulating Solution Produced by Wasted Gulonic Acid Mother Solution on Ginkgo Trees as Foliar Fertilizer.

Experiment method: two treatments are set up, with 10 five-year-old ginkgo trees in each treatment. In treatment 1, conventional fertilization of the ginkgo trees is carried out; 80 kg of urea, 20 kg of calcium magnesium phosphate and 50 kg of potassium sulphate are applied per 666.7 m²; 60% of the nitrogenous fertilizer is used as a base fertilizer, and 40% is used as a top dressing; 40% of the potassium fertilizer is used as a base fertilizer, and 60% is used as a top dressing. In treatment 2, based on the conventional fertilization of treatment 1, the fertilizer regulating solution product 5 of embodiment 5 diluted by 600 times is sprayed on leaves every 11th day for three consecutive times during the full bearing period of the ginkgo. As a control, in treatment 1, an equal amount of tap water is sprayed on leaves. Five days after the third spraying, the Vc content of the ginkgo leaves is determined.

The results show that the ginkgo leaves sprayed with the regulating solution (the fertilizer regulating solution product 5 of embodiment 5) are dark green, and the Vc content is as high as 109 mg/100 g, which is increased by 34.6% compared with that of the control group (81 mg/100 g).

### Application Example 17

### Experiment of Planting Rose by Using Regulating Solution Produced by Wasted Gulonic Acid Mother Solution as Water Soluble Fertilizer.

Experiment method: potted plants are used for experiment, and one rose tree is planted in each pot. Two treatments are set up, with five pots in each treatment. In treatment 1, conventional fertilization is carried out, and 15 g of compound fertilizer is applied in each pot. In treatment 2, based on the conventional fertilization of treatment 1, the fertilizer regulating solution product 3 of embodiment 3 diluted by 600 times is applied every 11th day for three consecutive times in one month before the flowering period. As a control, in treatment 1, an equal amount of tap water is applied. Except for this, other irrigation and fertilization conditions of the two treatments are the same. Ten days after the third spraying, the Vc content of the rose leaves is determined.

The results show that the leaves sprayed with the regulating solution (the fertilizer regulating solution product 3 of embodiment 3) are dark and thick. The Vc content of petals is as high as 15.2 mg/100 g, which is increased by 27.7% compared with that of the control group (11.9 mg/100 g).

The above only refers to preferred embodiments of the present invention. It should be noted that, for those ordinary skilled in the art, several variations and improvements can also be made without departing from the creative concept of the present invention, all of which belong to the protection scope of the present invention.

1. A regulating solution, fertilizer and soil conditioner for increasing Vitamin C (abbreviated as Vc, which is also known as ascorbic acid) content of plants, characterized in that the regulating solution is obtained by adjusting the pH value of a wasted gulonic acid mother solution or/and 2-keto-L-gulonic acid solution by an alkaline solution, wherein a fertilizer regulating solution is obtained by the pH value of the regulating solution to 3.0-9.0; a soil conditioner regulating solution is obtained by regulating the pH value of the regulating solution to 2.0-10.0; and the wasted gulonic acid mother solution or/and 2-keto-L-gulonic acid solution can be directly used as a regulating solution.

2. The regulating solution, fertilizer and soil conditioner for increasing Vc content of plants according to claim 1, characterized in that the alkaline solution is a solution with a concentration of 10-50 wt % prepared by an alkaline reagent and water, wherein the alkaline reagent is one or a mixture of more than one of sodium hydroxide, potassium hydroxide and liquid ammonia, etc.

3. The regulating solution, fertilizer and soil conditioner for increasing Vc content of plants according to claim 1, characterized in that 2-keto-L-gulonic acid is obtained by chemosynthesis or biosynthesis.

4. The regulating solution, fertilizer and soil conditioner for increasing Vc content of plants according to claim 1, characterized in that the regulating range of the pH value of the fertilizer is 5.5-7.5; and the regulating range of the pH value of the soil conditioner is 3.5-8.5.

5. A preparation method for the regulating solution, fertilizer and soil conditioner for increasing Vc content of plants according to claim 1, characterized in that the regulating solution is obtained by regulating the pH value of a wasted gulonic acid mother solution or/and 2-keto-L-gulonic acid solution by an alkaline solution, wherein a fertilizer regulating solution is obtained by regulating the pH value of the regulating solution to 3.0-9.0; and a soil conditioner regulating solution is obtained by regulating the pH value of the regulating solution to 2.0-10.0.

6. An application of the regulating solution, fertilizer and soil conditioner for increasing Vc content of plants according to claim 1, characterized by the application of the fertilizer regulating solution in increasing Vc content of plants and yield of crops; and the application of the soil conditioner regulating solution in preparing the soil conditioner.

7. The application according to claim 6, characterized in that the fertilizer regulating solution can be applied alone as a fertilizer, or applied after being mixed with one or more of a chemical fertilizer, an organic fertilizer, a biological fertilizer, a fertilizer raw material and a fertilizer auxiliary material.

8. The application of the regulating solution for increasing Vc content of plants according to claim 6, characterized by the application of the soil conditioner in regulating soil environment and increasing Vc content and yield of plants.

9. The application according to claim 8, characterized in that the soil conditioner is obtained by mixing the soil conditioner regulating solution with plant fibers at a mass ratio of 1:0-0.8.

10. The application according to claim 9, characterized in that the soil conditioner can be applied alone, or applied as a compound conditioner after being mixed with one or more of another soil conditioner, a chemical fertilizer, an organic fertilizer, a biological fertilizer and a soil conditioner raw material.
